(19) United States
(12) Patent Application Publication
(10) Pub. No.: US 2007/0083289 A1
(43) Pub. Date: Apr. 12, 2007

(54) Array mesh apparatus, system & methods

(76) Inventor: David Russell, Virginia Beach, VA (US)

Correspondence Address: David Russell, PO Box 913, Virginia Beach, VA, 23451-0913, US

(21) Appl. No.: 11/208,250

(22) Filed: Aug. 19, 2005

(51) Int. Cl. G06F 19/00

(52) U.S. Cl. 700/245; 901/1

(57) ABSTRACT

Disclosed are Array Element Mesh Systems (AEMSs) using configurable robotic surface(s) to “sample” 3D objects. Methods are disclosed for implementing “Array Element” components on flexible “interconnector substrate(s)”. Methods are disclosed, using Array Elements like “building blocks” to construct AEMSs. AEMSs sample, playback, and/or replicate 3D objects and/or 3d sequences. “Learning Mode” occurs when an AEMS spatially conforms to an object and acquires “3D shape data” to store it in memory. Optionally, acquired 3D shape data is displayed graphically. “Learning Mode” collects “shape data” representing sampled objects. In Playback Mode”, stored 3D shape data (e.g. a 3D-CAD image) is accessed and sent to movable joint position actuators, to move individual Array Elements to “playback” shape(s) of learned object(s), allowing designers to see “draft(s)” of designs, prior to prototyping. In “Replication Mode”, an AEMS “replicates” learned 3D shapes, to produce a “replication” using similar material(s) and/or functionality as sampled 3D objects.

### BACKGROUND OF THE INVENTION

1. Field of the Invention

The field of the invention is automatic (e.g., robotic) sampling, simulation, and replication; more particularly, three-dimensional (3D) sampling/simulation, for: (a) “learning” (i.e., “reading”, sampling, scanning, and/or measuring) 3D objects (e.g., to develop and store 3D images of sampled 3D objects); and/or (b) “playback” (i.e., sending stored 3D data to an AEMS for 3D duplication); and/or (c) “replication” of target 3D objects (i.e., production of useful tools or implements).

2. Related Art

There appears to be little or no directly related art. Notwithstanding, there appears to be some indirectly-related art which superficially addresses a few “framework”, static, concepts behind the present invention. However, this minimally-related art does not address the dynamic, operational capabilities of the present invention, nor does this minimally-related art function like the present invention, nor does the minimally-related art accomplish the stated objects of the present invention.

U.S. Pat. No. 4,715,638 to Chambers discloses a robotic hand with slip couplings. A robotic hand consisting of one or more jointed fingers each formed from a number of link elements is disclosed. A torque control is supplied for each element so that undue pressure is not exerted by any link element on an object being gripped. The invention provides an electromechanical simulation of a human hand, flexing to encompass objects rather than impinging against them. This invention appears to be directed to provide a mechanism for gripping against any object the articulated robotic hand can conform itself around, which is limited by the bending capacity of the hand-like mechanical appendages. Although the patent and the product it protects may have uses in the art that it is particularly suited for, the patent and product are unlike the present invention except for the fact that they both are articulated, but very differently so.

U.S. Pat. No. 6,205,533 to Margolus entitled “mechanism for efficient data access and communication in parallel computations on an emulated spatial lattice” discloses a mechanism for performing parallel computations on an “emulated spatial lattice” by scheduling memory and communication operations on a static mesh-connected array of synchronized processing nodes.

The lattice data are divided up among the array of processing nodes, each having a memory and a plurality of processing elements within each node. The memory is assumed to have a hierarchical granular structure that distinguishes groups of bits that are most efficiently accessed together, e.g., words or rows. The lattice data is organized in memory so that sets of bits that interact during processing are always accessed together. Such an organization is based on mapping the lattice data into the granular structure of the memories in a manner that has simple spatial translation properties in the emulated space. The mapping permits data movement in the emulated lattice to be achieved by a combination of scheduled memory access and scheduled communication. Moreover, the same mapping spreads interprocessor communication demands evenly over time.

While U.S. Pat. No. 6,205,533 to Margolus teaches apparently useful concepts relating to massively parallel processing or computing systems, the invention appears to address elaborate data manipulation and insertion processes in essentially a static processing environment that is essentially a simultaneous multiprocessing system. There is no mention of the dynamic sampling or simulation as disclosed in the present invention. While there are some superficial physical similarities in this Margolus invention to the present invention, the two are non-analogous beyond the superficial similarity of computationally-oriented “mesh” embodiments. The Margolus invention appears to be a static device—unlike the present invention, which is a dynamic device with an extremely high number of possible operational permutations and combinations.

U.S. Pat. No. 5,159,690, also to Margolus (et al) is entitled “multidimensional cellular data array processing system which separately permutes stored data elements and applies transformation rules to permuted elements”. The patent discloses a method for coordinating the activity of a plurality of processors in a computing architecture adapted to emulate a physical space, in which spatial locality is reflected in memory organization, including the steps of subdividing the emulated physical space, assigning memory to each subdivision, and assigning a processor to each assigned memory, respectively. A related data array computer for performing an iterative updating operation upon data bits (including a first circuit for performing data-blind data movement upon the data bits) is also disclosed.

While the above U.S. Pat. No. 5,159,690 appears to contribute to the study of cellular automata and large scale computational systems, it also appears to be a static device similar to the other Margolus patent cited earlier (U.S. Pat. No. 6,205,533).

Compared to the essentially static, massively parallel, computational nature of the Margolus inventions—even though the Array Mesh of the present invention indeed has rigorous computational aspects and characteristic—the present invention can be diversely, dynamically, physically manipulated and/or automatically manipulated to achieve desired ends of 3D sampling and/or 3D simulation.

U.S. Pat. No. 6,475,639 to Shahinpoor discloses “ion exchange membrane-based sensors, actuators and sensor/actuators” and methods of making same for applications requiring sensing, actuating and controlling displacement. Sensors, actuators, and sensor/actuators are purportedly useful in biological as well as other applications. Encapsulation of the sensors, actuators, or sensor/actuators purportedly increases the utility of the invention. Notwithstanding, Shahinpoor's patent and invention are not directly comparable to the present invention.

### NECESSITY OF THE INVENTION

It appears there's need in the art for dynamic, physically, spatially manipulated devices such as devices of the present invention, which are capable of sampling, simulating and/or replicating 3D objects; transmitting acquired 3D data to a computer or microprocessor; and converting 3D data to 3D images displayable on a display screen and/or images available for further processing. It also appears there is a need for a highly reconfigurable device which can transform itself into diverse shapes on demand (e.g., tools) which can subsequently be used to perform other work.

### OBJECTS OF THE INVENTION

It is one primary object, to provide dynamic, physically, spatially manipulated system devices, which “sample” and/or “simulate” 3D objects and (periodically or continuously) transmit sampled message data to a computer or microprocessor for image processing and/or other processing.

It is another primary object, to provide a version of the present invention which creates virtual 3D objects on a computer display screen, using one preferred embodiment which samples and simulates actual 3D objects.

It is yet another primary object, to provide a version of a system which upon command, assumes the physical and/or spatial dimensions of a 3D object (e.g., predetermined devices, such as a hammer, screwdriver, wrench, or other tools, etc.) upon command from a user or operator. It is a related object of the invention to provide a highly reconfigurable device which can be transformed into different shapes adaptable to different uses.

### SUMMARY OF THE INVENTION

This invention discloses an Array Element Mesh System (AEMS), which is constructed of “Array Elements”. An Array Element Mesh System is a system that uses a robotic (or robotic-like) surface to sense and replicate three-dimensional (3D) objects. Producing Array Elements on flexible, continuous, integrated, one-piece, multi-element “interconnector substrates” are also disclosed. Further disclosed are methods for embedding discrete Array Elements like “building blocks” to construct custom Array Element Mesh Systems.

An Array Element Mesh System (AEMS) can “sample” a 3D object (“Learning Mode”); “simulate” a 3D object (“Playback Mode”); and/or functionally “replicate” a 3D object (“Learn plus Playback and/or Replicate Mode”) and/or can move in 3D sequences (Learn plus Playback and/or Replicate, Over Time).

In a first preferred embodiment—Learning Mode—an AEMS (1) is manually made to conform to the shape of a 3D object; and after conforming thereto, the AEMS (2) acquires 3D shape data and sends the data to a computer. The computer can display this data in graphic format, if desired (or other user-stipulated formats). This permits the collection of 3D shape data from any object.

In a second preferred embodiment—Playback Mode—a spatial computer model of a 3D shaped object—e.g. a CAD image—can be inputted into an AEMS, instructing it to assume the 3D shape of the intended “target” 3D object. This permits a product designer (e.g.) to see a physical representation of his/her concept prior to actual formal physical prototyping.

In the third embodiment—Learning, Playback, and/or Replicate Mode—an AEMS can be made to conform to the shape of a physical object (Learning Mode), assume (simulate) the 3D shape of a chosen 3D object (Playback Mode), and/or replicate the functionality of the chosen 3D object. This permits a library of shapes to be collected, modified and replayed, as needed.

### DETAILED DESCRIPTION OF THE INVENTION

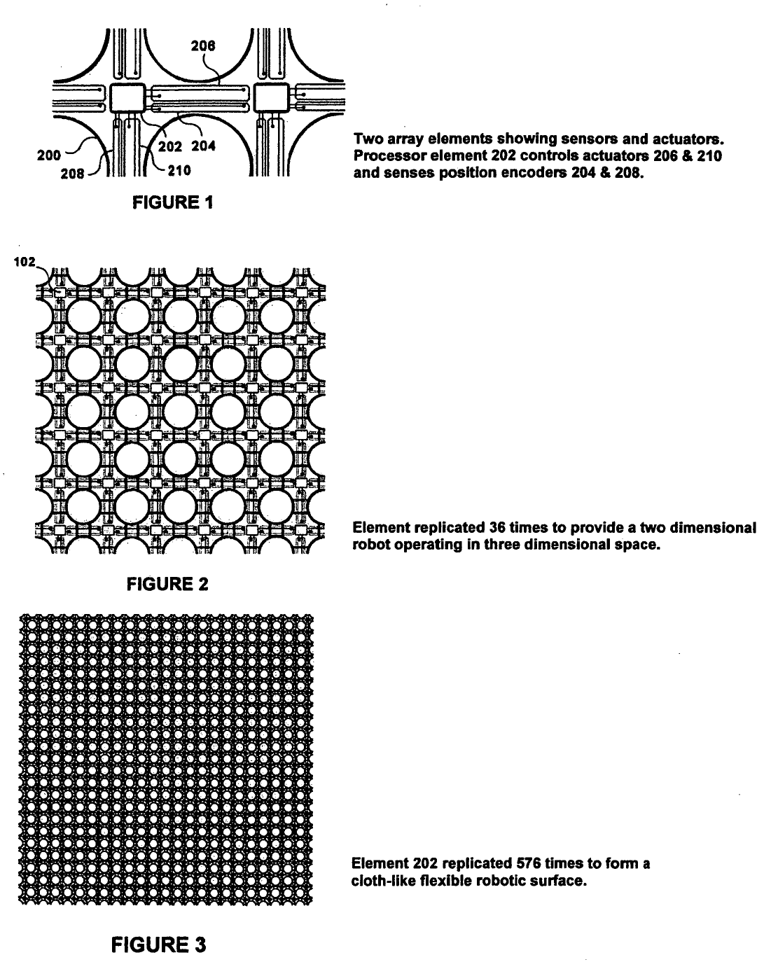

FIG. 1 shows a “two-Array Element” segment of an Array Element Mesh System (AEMS) implemented on a continuous, highly-flexible array element interconnector substrate such as an electro-active polymer (EAP) substrate (shown) or other adaptable stratum or substrate (not shown).

FIG. 1 also shows multiple circular apertures 200 (segments of 6 separate apertures are shown) surrounding left-side and right-side Array Elements. In general, in at least one primary embodiment of the invention, circular apertures optimally occupy a significant proportion of the surface area of some EAP-based (or other substratebased) AEMSs. Apertures add major flexibility and durability to an AEMS, and comprise a major proportion of some AEMS fabrications. Circular apertures (e.g., aperture 200) can also be a major part of the surface area of non-EAP-AEMSs, to help provide optimum flexibility.

Discussion of AEMS Nomenclature

NB: “Continuous AEMSs” (such as the AEMS shown in FIG. 1) are constructed (generally) in a “unitary” substrate. By contrast, “Discrete AEMSs” are constructed in (generally) interconnected multipart segments. Sets of interconnected multi-element substrates—i.e., the typical Discrete AEMS has “multiple-Array Elements-per-segment”—and can have either single array elements or multiple composite segments (e.g., with each segment having multiple array elements). Discrete AEMSs can be either composed of simple array elements (unitary array elements) or complex array elements (each having multiple array element segments). Discrete AEMSs can be constructed of either multiple individual discrete Array Elements, or, can be constructed of multiple discrete Array Elements or uniform discrete “super-segments” (i.e., multi-element, “element parcels”) comprising multiple interconnected Array Elements.

Additionally shown are east-west joint position actuator 206 and north-south joint position actuator 210, which are adjacent to “east-west” and “north-south” input/output/control lines (including communication links) interconnected between processors. Both actuators 206 and 210 are coupled into processor 202. Based on (e.g.) the movement and bending of actuators 206 and 210, as detected by position sensors such as east-west position sensor/encoder 204 and north-south position sensor/encoder 208, processor 202 receives “delta” data which relates changes sensed by position sensors.

It can be observed that in any large AEMS, there can be extremely large numbers of individual Array Elements, many of which directly move only in comparison to their adjacent Array Element(s), when the AEMS approximates any particular 3D object. Notwithstanding, segments of AEMS combinations, may be “flat” (i.e., no relative change of position occurs between some adjacent Array Elements, despite any absolute changes of position which occurs when an AEMS is moved to conform to a target 3D object).

Regardless which segments of an AEMS are “flat” (i.e., undeployed) and which segments of an AEMS are permutated (i.e., “non-flat”, deployed) for any particular target object conformed to by an AEMS, the status of all Array Elements in an AEMS are calculated after the AEMS has been conformed onto the target 3D object. In other words, accumulating the status of all combinations of Array Elements in an AEMS—differentiating the flat (undeployed) Array Element combinations from the permutated (non-flat, deployed) Array Element combinations—is an extremely critical aspect of the present invention. In other words, because the total Array Element relationships within the AEMS are gathered, accumulated, and summarized, the AEMS is able to determine how it has been deployed and what shape it has been morphed into. Detecting movement between relative positions of Array Elements, then analyzing all the changes, leads to aggregate determination of a target 3D object's physical shape, after examining the deployed and undeployed Array Elements outlining the target 3D object and conforming themselves thereto.

The symmetrical distribution of circular-shaped array element “center patterns” (e.g., “voids” such as aperture 200) disposed between individual Array Elements facilitates the tracking of Array Element movements in relation to adjacent Array Elements. The development and derivation of an orderly Array Element “firing” logic, based on each Array Element's microprocessor detecting one or more of its' interconnectors in “non-flat” (undeployed) and/or “flat” (undeployed) states.

For example, a hierarchical logic can be implemented, wherein each Array Element's interconnector components can be subsets of concatenated groups of Array Elements. Each Array Element, e.g., can be a member of a set of the next larger segment AEMS subset, e.g., one of a 1×1 and 2×2 and a 3×3; 4×4; . . . the calculating frame size of Array Element interrelations.

FIG. 2 shows another close-up view of a segment of an AEMS, also implemented in—and essentially disposed within—an electro-active polymer (EAP) substrate. AEMSs can also be disposed upon or within flexible PCBs; conductive fabrics; conductive foam (e.g., carbon-impregnated foam) or other conductive, semi-conductive, or non-conductive strata or substrates. AEMS capabilities will vary widely, depending on chosen substrates, number of Array Elements per unit area, type of electrical and/or mechanical connections between Array Elements, etc.

AEMS Array Elements can be uniformly disposed upon any viable substrate or stratum which is compatible with an efficient and effective installation of Array Elements and/or groups (segments) of Array Elements. The illustration in FIG. 2 depicts a 36 unit, 6×6 array element segment disposed within an electronic/electro-mechanical AEMS—such as an EAP—and is comprised of a continuous EAP carrier substrate which holds all Array Elements therewithin. FIG. 2 shows 36 array elements providing a predominantly variably configurable robotic surface operable in 3D space (three dimensional space).

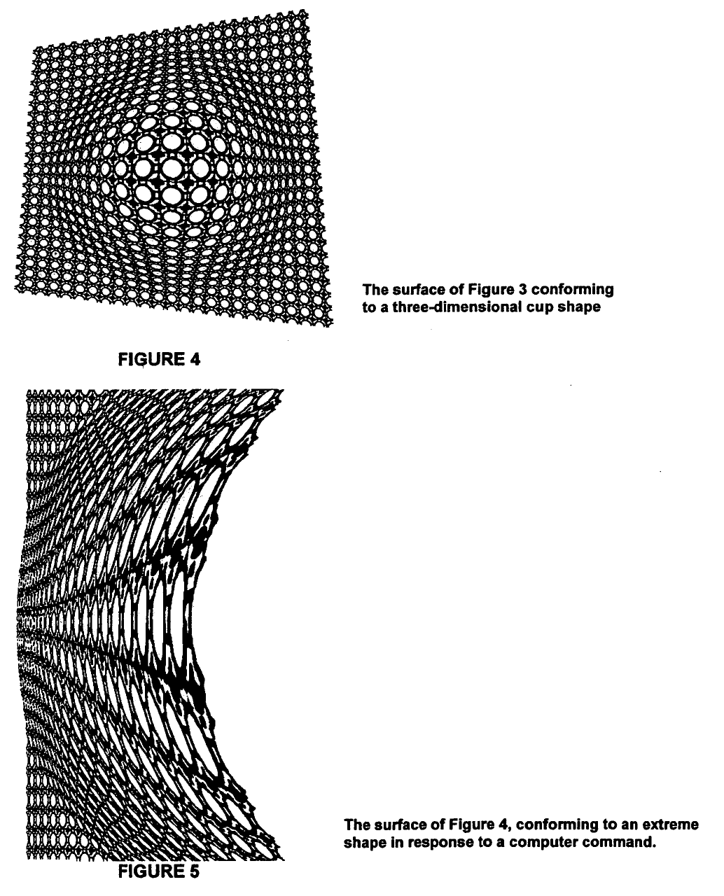

FIG. 3 shows an overview of 24×24 (576 array element) AEMS—also EAP-based, similar to that shown in FIG. 2—but without showing details such as strain gauges, processors, joint position actuators, joint position sensors, input“output/control lines and communication links, etc. In operation, the more granular the performance expected of any AEMS, the more array elements are needed to construct it, generally by using increasingly smaller form factor Array Elements in increasingly larger numbers per square area of AEMS surface area.

FIG. 4 shows an array element mesh system “in action”, statically deployed partially over a conical 3D object. It can be observed that the mesh is distended into a cone-like shape. The AEMS depicted is deployed upon a 3D object that's approximately shaped like a cone (i.e., it is sampling the conical 3D object). The fact that the mesh is covering over a cone-shaped form, is reflected in the conical visual display of the disposition of the mesh, after it has been conformed over the conical 3D object. It is observed that in many segments of the AEMS conformed over the conical object, entire sections of the AEMS are “flat” even though they are in fact deployed, relative to their zero state, a relative state where all Array Elements in the AEMS are flat and undeployed, relative to each other.

FIG. 5 also shows an array element mesh system “in action”, statically deployed partially over a large cylindrical 3D object. It can be observed that the mesh is distended in a cylindrical fashion, and it is observed that the mesh is deployed upon something with a cylindrical shape—such as a three-dimensional secant out of a 20″ diameter pipe (e.g., a water main). The fact that the mesh is covering over a cylinder is reflected in the cylindrical image representing the disposition of the mesh.

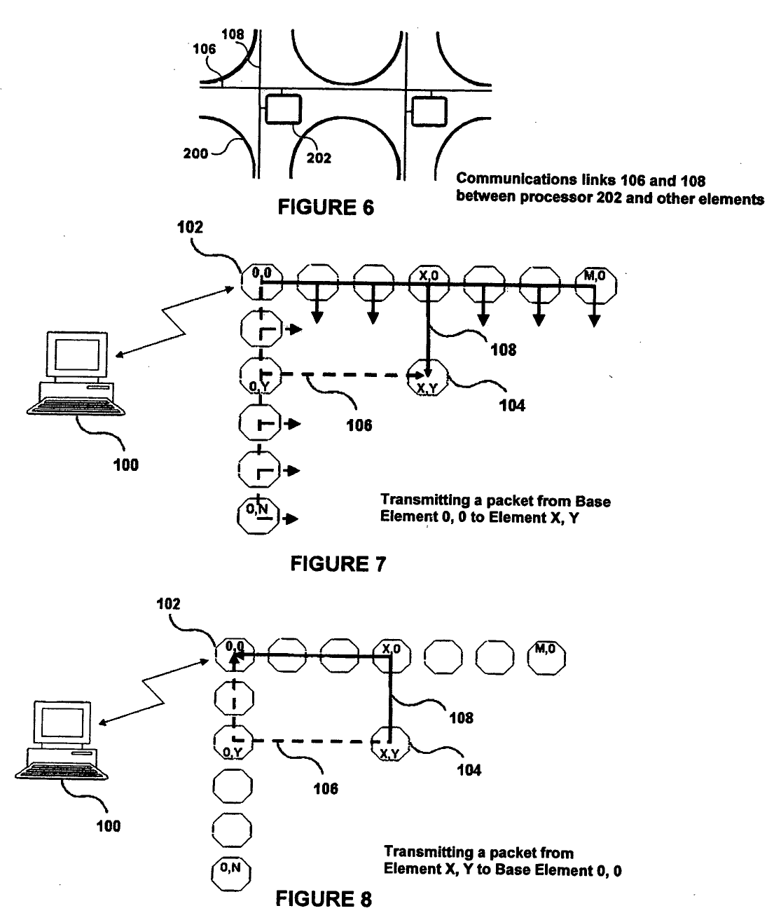

FIG. 6 shows additional detail comparable to FIG. 1, but also shows “north-south” input/output/control line 108 and “east-west” input/output/control line 106, both disposed within EAP common substrate interconnector arms interconnecting two Array Elements embedded in the EAP substrate. Both line 106 and line 108 are further coupled into a processor 202. Based on the movement and bending of the common interconnector arms shared between array elements which contain (a) joint position sensors 204 and 208 and (b) joint position actuators 206 and 210 and (c) input/output/control line 106 plus input/output/control line 108 (all of which are coupled to processor 202), processor 202 receives “delta” data and information, which relates changes sensed by the processor of one specific array element which senses relative movement changes from up to 4 directly adjacent array elements (i.e., the array elements directly adjacent thereto). Aperture 200 is also shown, having a circular shape. The symmetrical distribution of circular-shaped array element “center patterns” allows the development of an orderly array element logic, where each array element is essentially the logical intersection of 4 nominal interconnectors. In this case, aperture 200 demarks and delimits four (4) common substrate interconnector arms. Although no aperture is needed to facilitate calculation of the relative positions of adjacent Array Elements, the fact that apertures (i.e., such as voids) are implemented in the AEMS, can make much easier the detection of changes in the spatial relationships between Array Elements, combinations of flat and non-flat adjacent Array Element/Array Element interconnections.

FIG. 7 in summary, shows transmitting a data packet (i.e., a state message) sent from Base Array Element 0, 0 to Array Element X, Y. FIG. 7 introduces the concept of inter-AEMS (inter-Array Element) communications. The purpose of this exchange is to command Element X, Y to measure the two joint angles that it controls and return the data to the Base Element 0, 0.

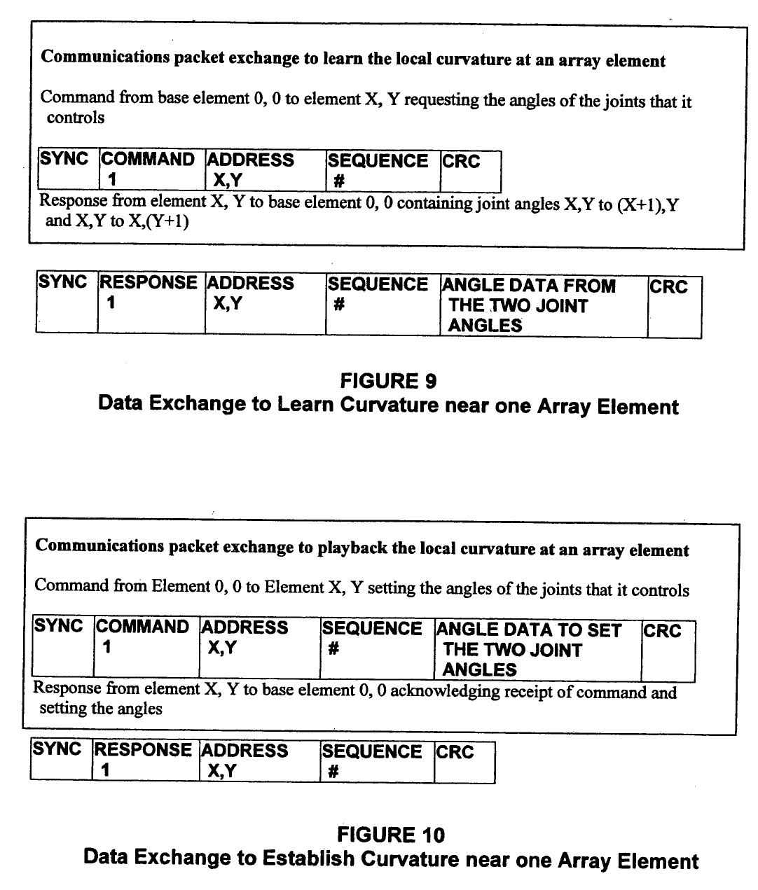

NB: The drawing shown in FIG. 9 refers back to FIG. 1 wherein the joint angles are measured by strain gauge pair 204 and strain gauge pair 208. The angle information from these strain gauge pairs are returned by Element X, Y to Element 0, 0.

Although implementation and configuration details can vary substantially between AEMSes, the example shown introduces the simple concept of a “Base Element” (“0, 0”) which is effectively a “master” Array Element on an AEMS (and/or AEMS segment) and/or is one of numerous “regional controllers” which accumulate shape data after deployment of an AEMS over a 3D object.

FIG. 7 depicts an example of how array elements are named typically in Cartesian form, where each X and Y pair combination signifies “row X” and “column Y”, making each X, Y pair formed at the intersection “X, Y”. The X, Y (row/column) nomenclature typically is used to uniquely name each and every intersection demarked by an Array Element at each row and column in any AEMS. The X, Y nomenclature can be used to locate any array element in an AEMS, a an AEMS segment (a subset group of an AEMS). Accordingly, after each Array Element has been polled for the state of its (up to 4) neighbors in relation to itself, the aggregation of array element perspectives are calculated at each intersection point in the AEMS, then AEMS wide calculations are made for determining on an intersection by intersection basis, the state of each Array Element segment in an AEMS.

To assist in calculating all Array Element shape data, an external computer interface is also possible, depending on configuration details and application details. Essentially, each array element and/or each master array element, gathers instantaneous data which defines the spatial orientation of the array element mesh. As shown in FIG. 3, the array element mesh system is “flat” which means there are no changes or “delta” data available, because the mesh is not deployed. When the mesh or any part of it moves, then there are change data, and this change data must be communicated within the mesh to a master array element or master array elements and/or external to the mesh, to an auxiliary computer.

FIG. 8 shows the transmitting of a data packet from Array Element (X, Y) to Array Element (0, 0). Array Element (0, 0) is also known as a “base element”, or a “master element”. This figure again illustrates the basic communication logic and messaging strategy in an AEMS. A Cartesian and/or hierarchical ordering of Array Elements, e.g., allows data to be sent from any uniquely located, X,Y locatable Array Element, e.g., to any other Array Element and/or to a “master element”, e.g., any base element comprising the “primary” data gathering element in a 1×1, a 2×2, a 3×3, or higher set group of Array Elements

FIG. 9 shows “data exchange to learn curvature near one Array Element.” Essentially, there is a communications packet exchange between Base Element (0, 0) and Array Element (X, Y) shown, wherein a supervisory processor coupled to Base Element (0, 0) commands Element (X, Y) to provide curvature data about its adjacent Array Elements (the top half of the message header), requesting the angles of the joints that it controls. Element (X, Y) responds to Element (0, 0) with the message in the lower half of the message header. The response from Element (X, Y) answers with a message containing joint angles (X, Y) to (X+1, Y) and (X, Y) to (X, Y+1).

FIG. 10 shows communications packet exchange following the path illustrated in FIG. 8 sending data to set joint angles between Element X, Y to Base Element 0, 0. The command packet sent to the Element X, Y sets the joint angles immediately to the right and below as shown in FIG. 1. Actuator pair 206 and actuator pair 210. The response packet simply acknowledges the receipt of the command and notifies the Element 0, 0 that the requested angular positions have been set.

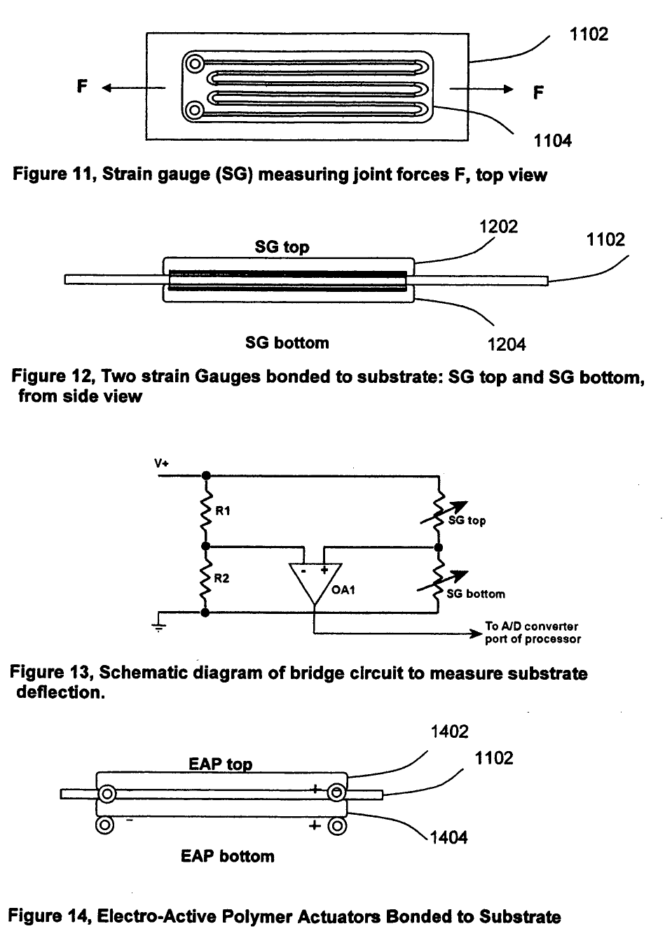

FIG. 11 details a typical strain gauge, labeled SG which responds with a small change of electrical resistance proportional to the change in length to the substrate 1102 to which the strain gauge 1104 is attached due to the applied forces F.

FIG. 12 shows two strain gauges mounted to the substrate such that a concave upward distortion of the substrate 1102 causes the top strain gauge 1202 to be subjected to a compressive force and the bottom strain gauge 1204 to experience a tensile force. In this way, a balanced strain gauge output is produced which can be used in a stable strain gauge bridge as described in the next figure.

FIG. 13 shows a strain gauge bridge which balances out the effect of resistance variation with temperature by placing the strain gauges in a differential bridge structure. The bridge circuit causes resistance changes due to temperature to be cancelled, as long as the two strain gauges are identical strain gauges and are bonded to the substrate in such a way that they experience the same temperatures. This is a typical strain gauge circuit as known in the art. Identical resistors R1 and R2 form the other half of the bridge and provide a reference voltage for the operational amplifier OA1 which senses the balance condition of the bridge. The gain of amplifier OA1 is set such that a maximum deflection of the substrate will unbalance the bridge sufficiently such that the output of the amplifier produces a high-level signal for the Analog-to-Digital port of the processor. The opposite deflection will produce a voltage for OA1 which will in turn produce the opposite the opposite (negative) signal to the A/D converter port of the processor. Thus, a very accurate digital measure of the joint angle can be obtained with simple microscopic electronic components.

FIG. 14 represents two (2) Electro-Active Polymer substrates 1102. The first EAP actuator 1402 is on the top of the substrate and the second EAP substrate 1404 is bonded to the bottom. When a voltage is applied to an EAP, it changes shape. For example, if power is applied to EAP 1402 to reduce its' dimensions, this will cause substrate 1102 to bend concave upward. If power is applied to EAP 1404, then it will bend concave downward. One output port of the processor is dedicated to each of the EAP actuators. If the processor has a D/A converter port, then the analog output can be used to drive the EAP actuator. If only a digital output is available, then the dwell time that a digital signal is active on this port will determine the amount of power that is applied to the EAP actuator. If this time is “ZERO”, then the EAP will be “flat” (i.e., undeflected). On the other hand, if the power is up for ½ of the time (square wave), then it will achieve approximately ½ of its' deflection. By controlling the duty cycle of the signal applied to the upper or lower actuator, it is possible to flex the substrate through a full range of possible deflections.

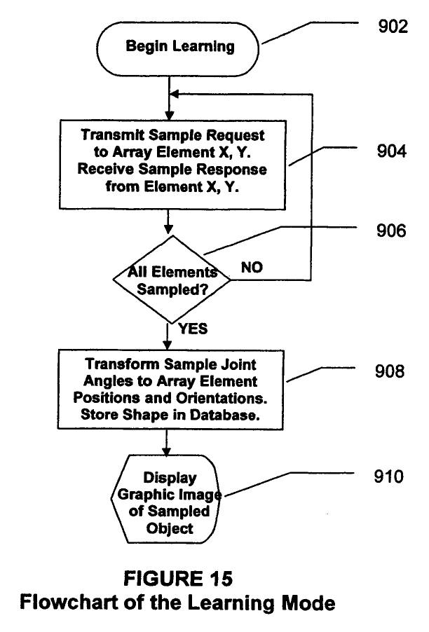

FIG. 15 shows the system flow chart illustrating the high-level general logic, summary steps, and sequence of the “Learning Mode” of the present invention. In step 902, the learning process is “enabled” and begins the process of learning a shape of a target 3D object. After enablement, (i.e., at “time zero”), the overall AEMS is in a static, initialized “zero position” (which is usually “flat” state, but “flatness” is not mandatory). In the zero position, there is no operable flexure of the AEMS; no work is being done. There is no flexure between and among array elements which (in toto) comprise the AEMS. (Multiple examples of an AEMS in various “zero position” states can also be observed in FIGS. 1, 2, and 3.) In the zero position state, there is no flexure of the flexible interconnector substrate upon which are coupled the interconnected array elements (which is interconnected to all the array elements in the AEMS). Terminal 100 is generally involved in Learning Mode process; however, terminal 100 may or may not be utilized in the Learning Mode (depending on implementation and configuration details). In step 904, a message packet (originally initiated by terminal 100, in this example) is transmitted from base element 0, 0 to array element X, Y through communications path 108. The purpose of the message packet transmission from base element 0, 0 is to inquire (i.e., to “poll”) the array element X, Y for its positional status; (i.e., the physical orientation of the array element X, Y.). This “polling” by base element 0, 0 gathers position data for all array elements in any given AEMS. While Base element 0, 0 (shown) as such, is the only base element in the drawings appended hereto, is only one of many possible joint position intelligence gathering and disseminating “control elements” implemented in an AEMS, in practice, the larger the AEMS and/or the more Array Elements it has, the more the data that will be exchanged therein.

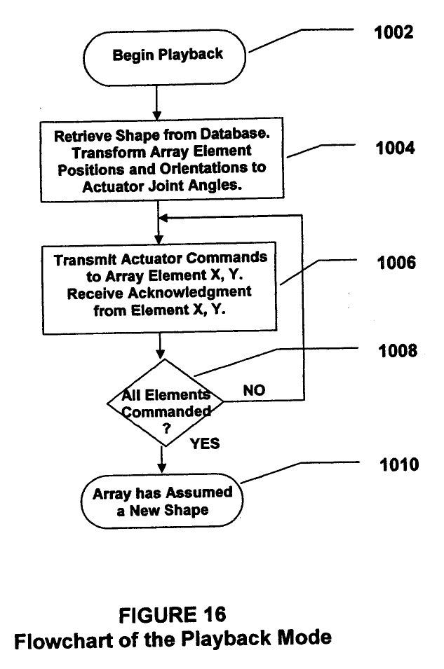

FIG. 16 shows the system flow chart illustrating general logic of “Playback Mode” of the present invention. Starting with logic module:
902—Start: beginning of learning process
904—Transmission of a sample request packet initiated by terminal 100 from base element 0, 0 to array element X, Y through communications path 108 and receiving a response packet in return.
906—Decision: until all elements have been sampled, loop back and continue sequentially transmitting to the array elements.
908—The join angle data that was received in the return response packets are stored in a table for use in future playback mode operations. They may also be transformed into array element positions and orientations for use in creating (CAD) graphic displays of the learned surface.
910—End: the transformed data may be displayed as an image of the learned surface.
1002—Start: beginning of playback process to set the array into a desired shape.
1004—Terminal 100 retrieves the joint angle data from a prior learning phase for playback. If position (CAD) input data is to be used, terminal 100 first converts the position information into join angle data using a set of forward robotic kinematic equations.
1006—Transmission of a position setting packet containing the joint angle data from terminal 100 to array element 0, 0 and then to array element X, Y through communications path 108 and receiving an acknowledgement packet.
1008—Decision: until all elements have had their positions set, continue to loop back and sequentially transmit to the array elements.
1010—End: when all elements have been set, the array will have assumed the desired shape. The learning mode may then be used to confirm that the desired shape has been achieved.

### LEARNING MODE DISCUSSION

In a first preferred embodiment as a learning device, the Array Element Mesh System (AEMS) is manually made to conform to the shape of a three dimensional object. When this has been accomplished, the operator instructs the computer to begin the learning process described in the flowchart of FIG. 9. The computer communicates with the microprocessor at base element 0, 0 and requests sample joint angle data from each element of the array using the internal communications network as illustrated in FIG. 8. The computer may store this information as a data array within a database, for example. This permits the collection of shape information from any object and the retention of a library of acquired shapes for analysis, prototyping or else replication as described in the next section. The computer can also transform this joint angle data into position and orientation data and can display this data into a graphic image of the object, if desired, so that the operator can verify its shape.

Playback Mode Discussion:

This is the second preferred embodiment as a replicating device. A spatial computer model of a three dimensional object, such as a CAD image or else a stored image obtained in the learning mode, may be transmitted to the device to instruct it to assume the shape of the intended item. If the shape data is in the form of position and orientation information, then it will be transformed into desired joint angles using a reverse-kinematic solution for the array equations. The joint angle data is sent to the appropriate array elements by means of the internal communications network as described in FIG. 10. When all array elements have been commanded to set their joint angles to the desired value, then the array will have assumed the desired shape. There are numerous robotic, display and other applications for such a shape forming capability, For example this embodiment permits a designer to see a physical representation of his concept prior to prototyping.

Combined Learning and Playback (“3D Object Replication”) Discussion:

In the third embodiment, the device can both be made to conform to the shape of a physical object (learning mode) and also can assume the shape of the object (playback mode) and/or the device can replicate the functionality of the target 3D object. This permits a library of shapes to be collected, modified and replayed and/or replicated, as needed. The process is simply a combination of the two foregoing embodiments as described in the sequence of FIG. 9 followed by that of FIG. 10. Additionally, combining Learning and Playback and/or Replicate over time, can provide an animated 3D object which simulates and/or replicates a target 3D object.

Basic Array Element Construction and Nomenclature

There are many different types and shapes of individual Array Elements. Individual Array Elements can be constructed into almost any (non-zero) spatial dimension (i.e., they may be of theoretically any size). However, most practically, for most implementations, Array Elements are physically “small”, sometimes microscopic in size, in some implementations. Array Elements are generally of “regular” symmetrical dimensions and are generally uniform in shape in each “class size”. There are theoretically no limitations to the size of array elements, beyond the laws of physics. For many micro- and nano-scale applications or man/machine interface applications, “smaller is better”, at least in terms of “granularity” and increasing detail derivable from the manipulation of any target Array Element Mesh System versus any contemplated application.

| Array Element Size: | | Array Elements/CM² | Array Elements/CM³ |
|---|---|---|---|
| 1.0 | CM | 1.0 | 1.0 |
| 0.5 | CM | 4.0 | 8.0 |
| 0.1 | CM | 100 = 10² | 1000 = 10³ |
| 0.01 | CM | 10,000 = 10⁴ | 1,000,000 = 10⁶ |
| 0.001 | CM | 1,000,000 = 10⁶ | 1,000,000,000 = 10⁹ |
| 0.0001 | CM | 10⁸ | 10¹² |

Utility versus Size Considerations

Interesting and utilitarian phenomena occur when array elements are logically and/or physically integrated with many other array elements, to form “Array Mesh Systems”. Accordingly, the utility of any Array Element Mesh System usually increases with increasing incidence of highly regular (often geometric or binary) Array Element form factors, based on any chosen application's needs.

Measurement of Spatial Relationships between Array Elements

Array elements bound and integrated together into an interconnected, electronically and/or mechanically embedded system can effectively become “simulation” and/or” measurement and/or “replication” devices which effectively can measure spatial relationships between them, and thereby in the process of measurement, be used to sample, simulate, and/or approximate and/or replicate the physical conformations of any appropriately-sized 3D object they are superimposed upon (or are replicating).

AEMSs are Observable in 3 Dimensions: “Flat” Versions versus “Solid” Versions

Array elements interconnected into Array Mesh Systems can be observed in three dimensions, even in “zero states” (inactive states). The third dimension (the “height”) of an array element mesh system is usually far lesser in magnitude than the relative magnitude of breadth and depth (i.e., “length” and “width”) of an Array Mesh System. Otherwise stated, interlinked array element mesh systems are generally substantially “longer” and “wider” than they are “tall”. Length and width of Array Mesh Systems are often similar (but this is not mandatory) and/or generally exhibit symmetry and/or geometric regularity.

The ratio of length to width to height is seldom less than 100:100:1. As Array Mesh Systems are built into larger and larger aggregations of array elements (i.e., as they become more granular with increasing numbers of increasingly smaller array elements), this ratio can exceed 100,000:100,000:1, however there are no theoretical limits for some highly granular array mesh systems, e.g., those that operate at the micro-, nano-, or molecular form factor application levels.

Utility of Integrated “Massive Population” Array Element Versions of AEMSs

One of the most efficient/effective array element mesh system implementations of array elements of any shape, type, or scale), is in an integrated massive implementation. Massive implementations of array elements into Array Mesh Systems are typically made via a mass-produced template, pattern, robotic assembly, or populated substrate of Array Elements manufactured together as an embedded system within a complementary substrate.

Basic Methods for Building & Operating Array Elements & AEMSs

Component Integration of Discrete Array Elements to Form Discrete AEMSs

A first method for building Array Element Mesh Systems, is to fabricate together individual Array Elements—each composed of shape(s), symmetries, and substrate(s) needed for one or more target application(s)—into a concatenated system, to form the integrated Array Element Mesh System. The functionality (limitations and powers) of any Array Element Mesh System is based on the shape(s), symmetries, substrate(s), fabrication details of its component Array Elements, and other application- and configuration-specific variables.

AEMS Design Optimally Depends on “Intended Application” (Work it will do)

It is important to determine what work any particular Array Element Mesh System will be required to perform before building it. When determining how to design and build an Array Element Mesh System, and determining which substrate(s) are needed for constructing its' Array Elements, and determining how many Array Elements should be used, the smallest spatial level of performance should be considered. The sampling and/or simulating and/or replicating operation required, dictates “requisite variety” dimensions to be specified, suitable to serve any specific application(s) or work that the Array Element Mesh System is expected to perform.

Obtaining “Increasing Precision” via “Increasing Density” of Array Elements

In general, the greater the density (volume) of Array Elements that are concatenated (per square area), the more “precise” the resulting Array Element Mesh System can be (i.e., increasing the volume of Array Elements increases the precision of the resulting Array Element Mesh System's three-dimensional sampling and simulation capabilities).

“En Masse” Fabrication of AEMSs

A second method for building Array Elements directly into an Array Element Mesh System is to fabricate Array Elements of predetermined parameters “en masse” into one or more substrate(s). Typically, underlying sheet(s) of “substrate”—e.g., flexible, durable, semi-conductive fabric; and/or glass and/or plastic used in fiber optics; and/or electro-active polymers; or other substrates—can be “cut away” to reveal individual Array Elements, and/or the substrate can be “populated” with discrete Array Elements, to form a specific configuration of an Array Element Mesh System. Alternatively, an “array element pattern” can be disposed upon a substrate to implement a multiplicity of interconnected Array Elements (generally symetrically organized, e.g., organized into columns and rows).

Perf Board-Based and/or Flex Circuit-Based AEMSs

A third (also “en masse”) method for building Array Elements into Array Element Mesh Systems (and a variation of the second method above) is to fabricate Array Elements onto a custom “perf board” (i.e., a perforated “breadboard” for building test circuits and the like) composed of a thin, durable, highly flexible substrate. Either hand-assembly can be used (for low resolution finished products) or robotic assembly using a “pick-and-place” machine (generally for high resolution finished products) can be employed.

Discrete Array Elements are Individual Circuits

In practice, the Array Elements in most all Array Element Mesh Systems are basically individual wired circuits and sub-circuits.

“Measuring Inter-Array Spatial Relationships” in AEMSs

In operation, generally there can be only one (of two possible) “measuring” (or spatial) states extant between any chosen set of two adjacent Array Elements—which manifests in either electrical continuity between that set of two adjacent Array Elements (usually, a “bend” correlating to a physical shape departure from “zero state position”—or manifests in no electrical continuity (indicating no “bend”, i.e., no departure from “zero state position”). It can be observed that the total physical and logical result of all such events of continuity (or lack thereof) across the Mesh as a whole—i.e., between and among all adjacent sets of Array Elements—yields the physical conformation of the Array Element Mesh System itself. The resultant physical conformation of the System is the “solution” to any instantaneous sampling/simulation “problem”: i.e., the System has completed its sampling and/or simulation after disposition upon the 3D object.

Basic Processor Considerations

One or more central processors and/or a multiplicity of distributed processors (e.g., such as PIC chips or the like, or smaller devices) record and/or track the spatial relationship between each set of adjacent Array Elements and/or multiple sets of adjacent Array Elements. The functioning of all (or all registerable) sets of adjacent Array Elements aggregates into a summative Array Element Mesh System state. The state of the entire Array Element Mesh System effectively can logically and/or physically “sample and/or simulate” actual physical 3D objects capable of being sampled and simulated.

Measuring Movement, Action & Change in a Dynamic Array Mesh

Measurement of Flexion

Once an array mesh has been fabricated and integrated and configured—either by assembly of array elements or by en masse fabrication into an array mesh—several different methods of measuring the movement or flexion of the array mesh can be used, such as the “admitted light” method; the “continuity” method; the “sequential state reporting” method; and others.

Admitted Light/Fiber Optic

In the “admitted light” method, one or more light sources can be directed into column(s) and/or row(s) (i.e., into the edge-side “head ends”) of Array Elements so constructed, and the amount of light exiting the “far ends” can be measured. Based on how much light emerges from the “far ends” it can be determined how far each array row or column has been bent, which can be interpreted as a calculable “bend” which correlates to a physical shape departure from “zero state position” (flat starting position).

General Integration of Array Elements to form AEMSs

Alignment and Integration of Array Elements

To build the present invention, a plurality of Array Element apparatuses are first properly aligned, interconnected, and then manufactured and/or (manually) assembled into “Array Element Mesh Systems” of the user's choice, based on the desired “work” the assembled system is expected to do. Array Element Mesh Systems in overall form, generally embed Array Elements between one or more layers of “holding substrates” (e.g., dielectric-bearing substrate(s) and/or other non-conductive or semi-conductive substrate(s)) and one or more layers of a partially conductive and very flexible (e.g., “fabric”-like or “sheet”-like) “carrier devices”, i.e., relatively freeform, foldable, lightweight, easily-portable “encapsulating devices” (often, non-conductive insulating devices).

Element/Element (Intra Army Mesh) Communications in an Array Mesh System

The Role of Array Element Mesh System Controller(s) in AEMSs

Adjacent Array Elements communicate with each other—and/or to one or more “Array Element Mesh System Controller(s)”—AEMSCs)—either by wired and/or by wireless message transmission. The system can be organized in specific ways (e.g., in x-y coordinates, with rows and columns). Each (“reporting type”) Array Element must always know what its' “orientation state” is with respect to its' immediately adjacent neighbors.

Reporting “Array Element Orientation State” to the AEMSC(s)

Each such (“reporting type”) Array Element must always be able to report its' “orientation state” on demand. Generally, in most implementations, each Array Element reports its “orientation state” either continuously, or periodically (discretely), and/or upon being polled (i.e. after being specifically requested to report its orientation state). Accordingly, “Orientation State Reports” (OSRs) are typically provided to (and/or requested by) adjacent (“neighbor”) Array Elements and/or by one or more “Array Element Mesh System Controllers” (AEMSCs). Such AEMSCs can comprise, e.g., one or more “Master Array Elements” (MAEs), which are typically one or more “master data processors”, microprocessors, or micro-controllers, etc., (depending on implementation details).

Array Element “Encapsulation” in the AEMS

“Carrier”-Like (e.g., Substrate) Fabrication

Array Elements are generally organized, interconnected, and encapsulated into one or more “carrier”-like substrates which are essentially multi-layer embedding devices. One or more of the substrate layers can be conductive or partially-conductive (e.g., carbon impregnated foam). One or more layers can be flexible encasements which effectuate a rubbery or “cloth-like” surface consistency) which is naturally freeform, foldable and portable. These multi-layer substrates can reliably, firmly, uniformly, and predictably constrain, “snug in” and “hard fix” Array Elements, e.g., by sewing, stitching, or “snapping” them into their predefined mesh slots or embedding places. Given this “hard fix” embedding, Array Elements are generally uniformly operable (and relatively predictable) together in most all flexion they sustain within the composite Array Element Mesh System during “mesh operation”, i.e., while the system is being “spatially manipulated.”

Embedded Operational Subsystem Components of Array Elements

Position Sensing Means Comprising a Variety of Motion Sensors

Typically, electrically active Array elements (e.g., MAEs and AEMSCs) of any particular Array Element Mesh System contain processing logic, memory, a communications means for communicating with other array elements, motive and/or flexing means (e.g. a motor and/or a flexor joint(s)), and a position sensing means for sensing its' orientation position relative to other electrically active, adjacent MAEs and AEMSCs. Alternatively, in some versions of Array Element Mesh Systems, component Array Elements of two different types are embedded: (i) “intelligent”, electrically-active Array Elements (with all the above components) are placed at regular intervals in the Mesh System, in between (ii) “passive” Array Elements which are effectively “place holding” and/or “transferences” Array Elements, which do not have all the intelligence of the “active” Array Elements, but which nonetheless perform important comparatively “passive” functions. More specifically, FIG. 1 describes an M by N mesh of Array Elements (labeled m, n) as noted on each element of the drawing.

Interconnection Joints

Each pair of adjacent Array Elements are interconnected by “interconnection joints” which are uniformly flexible in at least two dimensions (refer to the angles labeled θ and φ in FIG. ______ where one of these angles is an independent variable that is controlled as by a motor (and/or a flexor joint(s) capable of being manipulated) and the other angle is a dependent variable that is a passive flexible interconnection joint (or a motor). The angular position of at least one of these interconnection joints can be measured to determine its orientation position. The “quiescent” state—or “zero” state—of the Array Element Mesh System is a “flat” state in which the angles average to approximately “zero” across the device. Due to the flexibility of the individual joints, and the potentially vastly large number of (typically) very small Array Elements that can make up the Array Mesh, the surface of the Array Element Mesh System can superficially appear to be very supple and flexible (particularly for “high resolution” versions), equipping the Array Mesh to do high resolution, precision flexion and thereby, adapt to almost any surface shape.

Mechanical Actuator

FIG. ______ shows an Array Element with one or more mechanical actuator(s) ______ (e.g., “artificial muscle(s)” or “motor(s)”) that create and establish any Array Element's positional orientation with respect to its' adjacent Array Element. “Positional orientation” of any specific individual Array Element (i.e., a “reference” Array Element) is “sensed” (measured, calibrated, etc.) from perspective of that Array Element, to (e.g.) either one, two, three, or four adjacent Array Elements (but there is no limit to “adjacency” except physical space limits).

“Adjacent Pair Position Orientation”

FIG. ______ shows one example of a first preferred embodiment, where “adjacent pair position orientation determination” logic is used, the processor in each Array Element controls the mechanical actuator of the two revolute joints, e.g., θx and θy to the right of, and above, an individual reference Array Element

Flexible Substrates, such as EAPs and Other Options

The mechanical actuator(s) can be made of any suitable flexible material, e.g., electro-active polymers (EAPs) with sufficiently high enough dielectric constants to permit their usage and handling at relatively low voltages (which are safer for users and easier to power than lower dielectric constants). More specifically, “electro-active polymers” are plastics that expand or contract in the presence of an electric field, and these sensitive materials can become actuators or motors that can work much like biological motors. Previously, EAPs have had a low dielectric constant, in the range of 60, requiring a high voltage to produce motion. More recently, the required voltage has been reduced to that available within the range of batteries or computer logic by the addition of facilitating chemical additives (e.g., copper-phthalocyanine) that effectively raises the dielectric constant into the thousands, and thereby significantly lowering the effective operating voltages.

Electrostatic Motor Options Provide Joint Motion (a.k.a. “Inter-Interconnector” Movements)

Alternatively, conventional electromagnetic or electrostatic motors can be used to provide the joint motion, especially when implementations are used that employ “microelectronics technology” or even smaller “nanotechnology” to manufacture the Array Elements and the Array Mesh.

Resolution Considerations

NB: As “resolution” of Array Mesh System (number of Array Elements per unit area) increases, the importance of “joint angle resolution” of each Array Element decreases. For example, an Array Mesh System surface with thousands of Array Elements can be implemented with a simple binary actuator for each joint with only two positions—e.g., one position may be a few degrees up, the other may be a few degrees down. The effect of motion of many elements bending a few degrees each can cause a surface to bend into diverse shapes.

Joint Rotation Sensors

Joint rotation sensors are available that use optical, electrostatic or magnetic properties to sense position of one part of a revolute joint with respect to the other. These sensors known to robotic arts and can measure either revolute (rotating) or prismatic (sliding) joint motion. In one preferred embodiment, a simple position detector is used (e.g., the output of a strain gauge or a voltage produced by motion of an EAP). As the resolution of the elements increases to permit simple binary joint control, then the sensor will become a simple switch that detects only two states, bending up and bending down (i.e., upward flexion and downward flexion).

Basic Interconnected “2-Array Element”

Referring again to FIG. ______, it shows a simplified overview of a smallest possible embodiment of an “Array Element Mesh System” of the present invention is shown as a 1×2 Array Element Mesh System.

The “Zero State” of a Flat AEMS

As a backdrop, FIGS. ______ show a basic “static, or “zero state” Array Element Mesh System, i.e., the mesh is not in operation. When the array is 100% “static” in this way—i.e., laid flat and stretched evenly on a solid even surface, with no manipulations or changes having been made—the array produces no dynamic data which results in no “delta” message. In this state, the Array Element Mesh System Controller “knows” the array is in the “Zero State”. If any of the Array Elements were polled to request their “orientation state”, the sampling message data segment that each Array Element would transmit to the Controller 999 would be ZERO (0). The Controller 999 will assemble all the Array Element orientation data into

Binary Logic Version Options: Two States of Nature: “1's and 0's” (Sound Familiar?)

Physically, upon manipulation, the simplest, first primary embodiment of the invention only moves in one direction. This means only “1” or “0” is set in each of eight directions—in the case of an octagonal polygonal Array Element—meaning, eight bits (one byte) can represent the orientation state of one Array Element, in its' simplest embodiment.

“Reference” Array Elements vs. “Adjacent” Array Elements (Single, Multiple Massive States)

This first primary embodiment uses a “fully segmented”, concatenated mesh of electromechanical array elements (mesh structural components) which together form an interconnected, unitary structure. Logically, the overall output from this first primary embodiment is an “accumulation” of the aggregated states of all the array elements situate in the Array Element Mesh.

High Flexibility and Maneuverability

The Array Element Mesh functions such that it can be easily arranged into any of an extremely large number of different three-dimensional shapes, or conformations. Depending on the shape the Array Element Mesh is arranged, placed, twisted, or molded into, there is a characteristic summative signal associated therewith. If for example, an “empty flower pot” is used as a starting point for a device of the present invention . . .

Depending on any particular 3-D shape of electrical signals associated with variable shapes of the Gear Array Mesh. The best way to implement this invention is using “micro-scale” or “nano-scale” components.

Additional Reference Numerals

100—Host computer sending commands to array element 102 and receiving responses.
102—Base element at array location 0, 0 connected directly to host computer 100.
104—Element X, Y being selected on the internal network of the array.
106—Horizontal communications link that may contain multiple wires to provide power to the processors and communicate data.
108—Vertical communications link that may contain multiple wires to provide power to the processors and communicate data.
200—Circular aperture to increase flexibility while resisting tearing.
202—Processor on flexible substrate with memory, communications links, two sensor input ports, and two actuator control ports.
203—Second processor on the flexible substrate
204—Strain gauge to sense joint-angle position between elements 202 and the next element 203 to the right of it in the array
206—Electro-active polymer substrate to actuate the joint between elements 202 and 203.
208—Strain gauge to sense joint-angle position between element 202 and the next element below
210—Electro-active polymer substrate to actuate the joint between element 202 and the next element below
902—Start: beginning of learning process
904—Transmission of a sample request packet initiated by terminal 100 from base element 0, 0 to array element X, Y through communications path 108 and receiving a response packet in return.
906—Decision: until all elements have been sampled, loop back and continue sequentially transmitting to the array elements.
908—The join angle data that was received in the return response packets are stored in a table for use in future playback mode operations. They may also be transformed into array element positions and orientations for use in creating (CAD) graphic displays of the learned surface.
910—End: the transformed data may be displayed as an image of the learned surface.
1002—Start beginning of playback process to set the array into a desired shape.
1004—Terminal 100 retrieves the joint angle data from a prior learning phase for playback. If position (CAD) input data is to be used, terminal 100 first converts the position information into join angle data using a set of forward robotic kinematic equations.
1006—Transmission of a position setting packet containing the joint angle data from terminal 100 to array element 0, 0 and then to array element X, Y through communications path 108 and receiving an acknowledgement packet.
1008—Decision: until all elements have had their positions set, continue to loop back and sequentially transmit to the array elements.
1010—End: when all elements have been set, the array will have assumed the desired shape. The learning mode may then be used to confirm that the desired shape has been achieved.

I claim:

1. An array element apparatus for sensing positions of adjacent array elements and for sensing changes in relative positions of said adjacent array elements, comprising:
at least one flexible interconnector substrate for interconnecting and coupling said array element apparatus and said adjacent array elements;
at least one joint position sensor coupled to said at least one flexible interconnector substrate and further coupled to at least one processor; and
at least one input/output/control line including a communication link coupled to said at least one flexible interconnector, said at least one joint position sensor, and said at least one processor.

2. The apparatus of claim 1, further comprising at least one power source.

3. The apparatus of claim 2, wherein said power source further comprises but is not limited to at least one of an electrical source and an electromagnetic source and a magnetic induction source and a electrostatic source and chemical source and a photonic source and a radiant source.

4. The apparatus of claim 1, further comprising at least one joint position actuator coupled to said at least one processor.

5. The apparatus of claim 1, further comprising at least one local network coupled to said at least one processor.

6. The apparatus of claim 1, wherein said at least one flexible interconnector substrate is comprised of at least one flexible structural material having at least two dimensions, and wherein said at least one flexible interconnector substrate is flexible in three dimensions.

7. The apparatus of claim 6, wherein said at least one flexible interconnector substrate is adapted to include components disposed within said array element apparatus.

8. The apparatus of claim 1, wherein a plurality of said array element apparatus comprises an array element mesh system.

9. The apparatus of claim 1, wherein said array element apparatus is coupled to said at least one flexible interconnector substrate at areas of flexure disposed between said array element apparatus and said adjacent array elements.

10. The apparatus of claim 1, wherein the surface area of said array element apparatus is smaller than the surface area of said at least one flexible interconnector substrate.

11. The apparatus of claim 1, wherein the surface area of said array element apparatus is approximately equal to the surface area of said at least one flexible interconnector substrate.

12. The apparatus of claim 1, wherein said at least one joint position sensor coupled to said at least one processor is further coupled to said at least one flexible interconnector substrate at areas of flexure disposed between said array element apparatus and said adjacent array elements, wherein said at least one joint position sensor is adapted to respond to at least one command, wherein said at least one joint position sensor is further adapted for sensing and reporting position and movement of at least one of said adjacent array elements in relation to said array element apparatus, and wherein said at least one joint position sensor is also adapted to store data in and retrieve data from the memory of said at least one processor.

13. The apparatus of claim 4, wherein said at least one joint position actuator coupled to said at least one processor is further coupled to said at least one flexible interconnector substrate at areas of flexure disposed between said array element apparatus and at least one of said adjacent array elements, wherein said at least one joint position actuator is adapted to be respond to at least one command, wherein said at least one joint position actuator is also adapted to move to adjust the position of at least one of said adjacent array elements in relation to the position of said array element apparatus, and wherein said at least one joint position actuator is adapted to store data in and retrieve data from the memory of said at least one processor.

14. The apparatus of claim 12, wherein said at least one command is issued by one of a processor internal to said array element apparatus and a processor external to said array element apparatus, and wherein said at least one command further comprises but is not limited to at least one of: (1) a sense position command, (2) a report position command, (3) a learn position command, (4) a move position command, and (5) a set position command.

15. The apparatus of claim 13, wherein said at least one command is issued by one of a processor internal to said array element apparatus and a processor external to said array element apparatus, and wherein said at least one command further comprises but is not limited to at least one of: (1) a sense position command, (2) a report position command, (3) a learn position command, (4) a move position command, and (5) a set position command.

16. The apparatus of claim 13, wherein said at least one joint position actuator is adapted to respond to said at least one command, and wherein said at least one joint position actuator is further adapted to respond by moving at least one of said adjacent array elements from a first position to a second position in relation to said array element apparatus.

17. The apparatus of claim 5, wherein said at least one local network is adapted to exchange data between said at least one processor and at least one other processor.

18. The apparatus of claim 17, wherein said at least one local network is further adapted to exchange data between and among said at least one processor, at least one supervisory processor, and at least one other processor coupled to an external system.

19. The apparatus of claim 5, wherein said at least one local network includes at least one conductive wired LAN circuit coupled to said at least one flexible interconnector substrate, wherein said at least one local network is coupled to a network transceiver included within said at least one processor, and wherein said at least one local network is coupled to a network transceiver included within said at least one processor, and wherein said at least one local network is coupled to at least one network transceiver external to said at least one processor.

20. The apparatus of claim 5, wherein said at least one local network is includes at least one wireless WPAN circuit coupled to said at least one flexible interconnector substrate, wherein said at least one local network is coupled to a wireless network transceiver included within said processors, and wherein said at least one local network is coupled to said wireless network transceivers included within said at least one processor.

21. The apparatus of claim 5, wherein said local network is comprised within said array element apparatus, wherein said local network is adapted to communicate with a network external to said array element apparatus to allow an external system to exchange data between and among said array element apparatus and said adjacent array elements and at least one processor, and wherein said local network is adapted to send and receive joint position information from said array element apparatus and said adjacent array elements.

22. The apparatus of claim 13, wherein said at least one command is provided in parametric form and is further provided according to a predetermined frequency.

23. An array element mesh system comprising a variably configurable robotic surface, further comprising:
a plurality of interconnected array elements coupled to at least one flexible interconnector substrate;
each of said plurality of interconnected array elements further comprising at least one of a processor and a supervisory processor and a joint position sensor and a joint position actuator and an input/output/control line including a communication link;
at least one local network;
at least one network connection to at least one of said processor and said supervisory processor; and
software instructions executing within at least one of said processor and said supervisory processor for issuing commands to at least one of said plurality of interconnected array elements.

24. The system of claim 23, wherein said system is further adapted for at least one of but is not limited to: (1) sampling and simulating a target 3D object, and (2) sensing positions of at least one array element in relation to at least one other array element, and (3) learning 3D shape data from said 3D object, and (4) playing back learned 3D shape data, and (5) replicating at least one of the function and the shape of said 3D object if said system is capable of replication thereof.

25. The system of claim 23, further comprising a power source, wherein said power source further comprises but is not limited to at least one of an electrical source and an electromagnetic source and a magnetic induction source and a electrostatic source and chemical source and a photonic source and a radiant source.

26. The system of claim 23, wherein said local network is adapted for coupling said processor and said supervisory processor to at least one other processor, and wherein said at least one other processor is at least one of included within said system and external to said system.

27. The system of claim 23, wherein said software instructions provide programming steps and commands to do at least one of: (1) sense and report joint position status data characteristic to a sampled 3D object, and (2) move at least one array element from a first position to a second position to conform said system to the surface of said 3D object, and (3) sense and report changed joint position status data after moving said at least one array element, and (4) learn joint position status data characteristic to said 3D object, and (5) playback at least one joint position characteristic to said 3D object, and (6) at least one of simulate and replicate said 3D object if said system is capable thereof.

28. A method of operating an array element mesh system to sample, learn, and playback a 3D shape of a target 3D object, comprising the steps of:
selecting a target 3D object to sample, learn, and playback;
initializing said array mesh system to a zero state prior to wrapping and conforming said system over said target 3D object surface;
at least one of wrapping and conforming said array mesh system onto said target 3D object to approximate the physical shape of said selected target 3D object;
sending at least one command from at least one of a processor and a supervisory processor to at least one of a joint position sensor for sensing joint position data and a joint position actuator for changing joint position data by moving at least one array element of said system to sample, learn, and measure said target 3D object;
receiving said at least one command in one of a joint position actuator and a processor and a supervisory processor to allow one of said processor and said supervisory process to accomplish at least one of (1) sampling, and (2) learning, and (3) playing back specific learned joint angle positions measured between adjacent array elements of said array mesh system;
exchanging data between at least one processor to at least one supervisory processor to report joint positions of adjacent arrays;
receiving at the supervisory processor said at least one joint angle message and processing this data in a program for converting said at least one set of joint angle data into three dimensional representations and images;
executing said program for converting said at least one set state message data into 3D three dimensional images;
storing at least one of the joint position status data including angular position data representing a sampled 3D object image data for future reference; and
displaying said 3D three dimensional images on a display screen.

29. A method of operating an array mesh system to generate a desired 3D physical shape to simulate a learned 3D object, the steps comprising:
selecting from a processor memory, a learned set of array element joint positions representing said learned 3D object;
converting said learned set of joint positions characteristic to said desired 3D object into instructions executable by said at least one array element;
issuing commands by at least one of a processor and a supervisory processor to at least one of a joint position sensor and a joint position actuator comprised within at least one army element included within said array mesh system;
executing said commands by said at least one array element in order to simulate the shape of said 3D object;
setting and adjusting joint position actuators to execute changes in joint position angles for at least one array element comprised within said system to conform said at least one array element to simulate the physical shape of said 3D object.

30. The system of claim 29, wherein said learned set of said array element joint positions further comprise an AEMS-executable set of angular position and array element movement commands for setting array element joint positions characteristic to said desired 3D shape; and wherein said learned set of said array element joint positions additionally comprise a kinematic equation executing on at least one processor having kinematic software program instructions and a command language structure for rendering and displaying at least one of an image representing said desired 3D object and a form representing a physical simulation of said desired 3D object.

31. The method of claim 29, wherein said instructions comprise kinematic data including desired joint position angle data and desired array element movement data, and wherein said instructions further comprise kinematic software.

32. A polymorphic robotic surface that can configure itself in three dimensions to execute at least one of sampling, simulating, and replicating of the physical surface of a target 3D object, said robotic surface having a plurality of array elements with a common data communications means, and wherein said plurality of array elements are connected having at least two degrees of freedom characteristic to at least one of a rotational robotic joint and a translational robotic joint including means for manipulating said at least one of said joint and measure the amount of joint movement.

33. A self-configurable polymorphic robotic surface configurable in three dimensions for sampling and simulating the physical surface of solid objects, further comprising:
at a plurality of array elements including common data communications means and including at least three sides and at least three vertices, wherein said vertices have at least two degrees of freedom and include at least one of a rotational robotic joint and a translational robotic joint including means for manipulating each joint and for measuring the amount of joint movement;
at least one processor including at least one memory for storing the orientation state of said array elements of said polygonal robotic surface so that their positions can be saved and recalled;
at least one joint manipulator means for each robotic joint that can place each of said joint into a previously learned position in order to make the robotic surface simulate a desired object; and
interconnection means for interconnecting at least one of said array elements with at least one adjacent array element.

34. The robotic surface of claim 33, wherein said robotic surface is capable of being commanded to learn a sequence of array element orientations as it is manipulated by external conditions, including but not limited to manual application and operation by a user.

35. The robotic surface of claim 33, wherein said robotic surface is responsive to at least one command to replay and playback a learned sequence of array element joint position orientations to generate a sequence of at least one moving 3D object simulation to simulate a previously learned 3D object.

36. The robotic surface of claim 33, wherein said robotic surface is responsive to at least one command to initiate a new sequence of array element joint position orientations in order to generate a new sequence of at least one moving 3D object replication further comprising said robotic surface in motion.
